(19) United States
(12) Patent Application Publication
(10) Pub. No.: US 2009/0100466 A1
(43) Pub. Date: Apr. 16, 2009

(54) Electronic program guide (EPG) referencing past television content

(75) Inventor: Charles J. Migos, San Francisco, CA (US)

Correspondence Address: MICROSOFT CORPORATION, ONE MICROSOFT WAY, REDMOND, WA, 98052, US

(73) Assignee: Microsoft Corporation, Redmond, WA (US)

(21) Appl. No.: 11/974,815

(22) Filed: Oct. 16, 2007

(51) Int. Cl. H04N 5/445; G06F 13/00; G06F 3/00

(52) U.S. Cl. 725/40; 725/58; 725/55

(57) ABSTRACT

Techniques are described that involve an electronic program guide referencing past television content. In an implementation, a reference to an episode of television content that has already been broadcast is output in an electronic program guide. An event is scheduled that relates to another episode of the television with the reference to the television content that has already been broadcast.

### BACKGROUND

Users have access to an ever increasing variety of content, such as from cable and satellite television to streaming television content via the Internet. Consequently, users are now able to access hundreds of channels that may have different types of television content, such as television programs, video-on-demand, movies, sporting events, and so forth.

One technique that has been developed to help the users navigate through this vast amount of content is through the use of an electronic program guide (EPG). The EPG provides functionality similar to a printed program guide by informing the users as to which television content is available and where that television content is located, e.g., what channel is broadcasting the particular television content. The EPG may also provide additional functionality to enable users to actually navigate to particular television content represented in the EPG, cause the content to be recorded by a digital video recorder, order pay-per-view content, and so on.

Traditional EPGs, however, were limited to representation of content that is currently available or that will be available in the future. This is due to the traditional “forward thinking” notion of EPGs that addressed current and future content. This notion, however, did not address knowledge that a user might have of television content that just aired, such as a program that the user “just missed” when turning on a television.

### SUMMARY

Techniques are described that involve an electronic program guide referencing past television content. In an implementation, a reference to an episode of television content that has already been broadcast is output in an electronic program guide. An event is scheduled that relates to another episode of the television content through interaction with the reference to the television content that has already been broadcast.

In another implementation, one or more computer readable media include instructions that are executable to display in an electronic program guide a reference to a past episode of television content that is selectable to cause recordation of one or more future episodes of television content.

In a further implementation, a client includes one or more modules to display a reference to television content that has already been broadcast. The reference is selectable to schedule an event relating to other television content that is not the television content in the displayed reference.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

### BRIEF DESCRIPTION OF THE DRAWINGS

The detailed description is described with reference to the accompanying figures. In the figures, the left-most digit(s) of a reference number identifies the figure in which the reference number first appears. The use of the same reference numbers in different instances in the description and the figures may indicate similar or identical items.

FIG. 1 is an illustration of an environment in an exemplary implementation that is operable to employ techniques related to electronic program guides (EPG) that reference past television content.

FIG. 2 is an illustration of an embodiment of an exemplary electronic program guide (EPG) as being output and displayed at a client of FIG. 1 that includes functionality to reference past television content.

FIG. 3 is an illustration of an embodiment of the exemplary EPG of FIG. 2 as being output and displayed on a display device to reference past television content.

FIG. 4 is an illustration of an embodiment of the exemplary EPG of FIG. 2 as being output and displayed on a display device to set one or more events based on interaction with one or more references to past television content.

FIG. 5 is a flow diagram depicting a procedure in an exemplary implementation in which a reference of an episode of television content that has already been broadcast is output and an interface is provided to schedule an event that relates to another episode of the television content.

### DETAILED DESCRIPTION

Overview

Electronic program guides (EPGs) were developed to aid users to navigate through the vast amount of television content that is now commonly available as well as to perform other functions related to the television content, such as to schedule recordation, purchase conditional access rights (e.g., pay-per-view) and so on. Traditional EPGs, however, used a “forward thinking” notion and thereby limited display of television content to that which is currently being displayed or will be displayed sometime in the future.

This “forward thinking” notion did not address the knowledge a user might have of television content that had just “been aired” and therefore did not leverage efficiencies that may be gained through use of this knowledge. For example, a user may be late getting home to watch a recently-aired episode of the user's favorite television program. Because the recently-aired episode was no longer being aired, the episode was not longer made available in traditional EPGs. Therefore, to record a future episode of the television program (e.g., to make sure that the user doesn't miss the future episode), the user was required to search for that future episode. Additionally, this search may be inefficient as the user may not be aware of when the future episode is to be aired, if at all, e.g., the episode may be preempted by a sporting event.

Techniques are described to reference past television content in an electronic program guide (EPG). In an implementation, “past” airings of television content are persisted in the EPG and leveraged to locate other television content. For example, a reference to a past episode of television content in an EPG may be selected by a user to record future episodes of the television content. In this way, the user may leverage knowledge of television content that has already been-broadcast in-order to locate current and/or future content of interest, further discussion of which may be found in relation to the following figures.

In the following discussion, an exemplary environment is first described that is operable to perform techniques to represent past television content in an EPG. Exemplary procedures are then described that may be employed in the exemplary environment, as well as in other environments. Although these techniques are described as employed within a television environment in the following discussion, it should be readily apparent that these techniques may be incorporated within a variety of environments without departing from the spirit and scope thereof.

Exemplary Environment

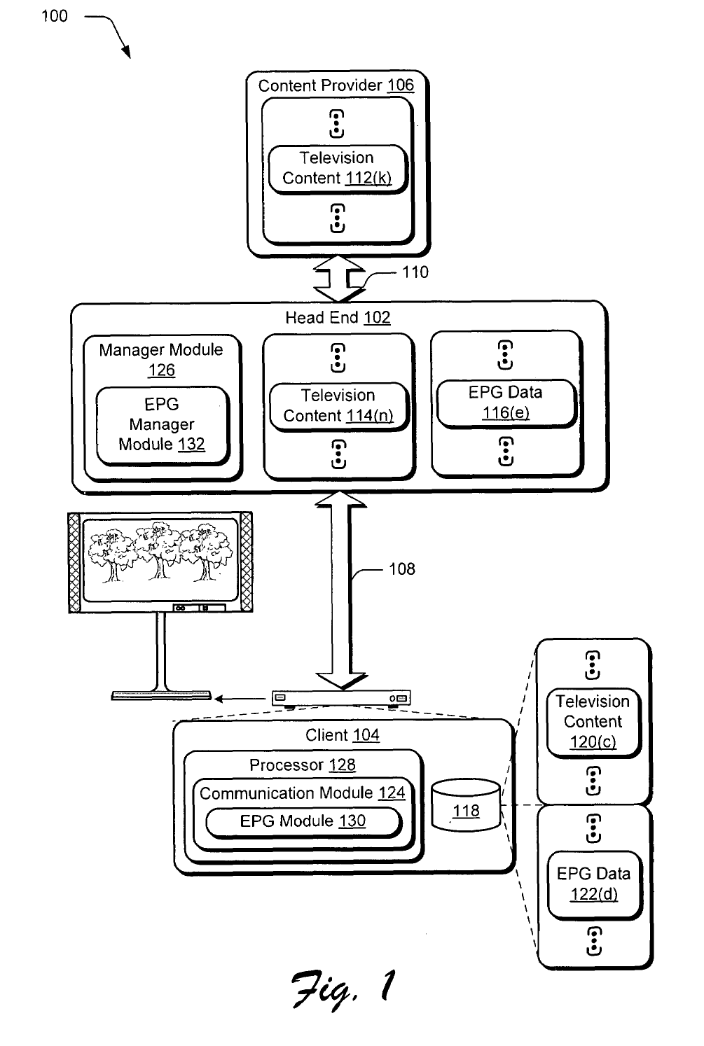

FIG. 1 is an illustration of an environment 100 in an exemplary implementation that is operable to reference past television content in an electronic program guide. The illustrated environment 100 includes a head end 102 of a network operator, a client 104 and a content provider 106 that are communicatively coupled, one to another, via network connections 108, 110. In the following discussion, the head end 102, the client 104 and the content provider 106 may be representative of one or more entities, and therefore reference may be made to a single entity (e.g., the client 104) or multiple entities (e.g., the clients 104, the plurality of clients 104, and so on). Additionally, although a plurality of network connections 108, 110 are shown separately, the network connections 108, 110 may be representative of network connections achieved using a single network or multiple networks. For example, network connection 108 may be representative of a broadcast network with back channel communication, an Internet Protocol (IP) network, and so on.

The client 104 may be configured in a variety of ways. For example, the client 104 may be configured as a computer that is capable of communicating over the network connection 108, such as a desktop computer, a mobile station, an entertainment appliance, a set-top box communicatively coupled to a display device as illustrated, a wireless phone, and so forth. For purposes of the following discussion, the client 104 may also relate to a person and/or entity that operate the client. In other words, client 104 may describe a logical client that includes a user, software and/or a machine.

The content provider 106 includes one or more items of television content 112(k), where “k” can be any integer from 1 to “K”. The television content 112(k) may include a variety of data, such as television programming, video-on-demand (VOD) files, and so on. The television content 112(k) is communicated over the network connection 110 to the head end 102. In the following discussion, television content may also be referred to simply as “content”.

Television content 112(k) communicated via the network connection 110 is received by the head end 102 and may be stored as one or more items of television content 114(n), where a “n” can be any integer from “1” to “N”. The television content 114(n) may be the same as or different from the television content 112(k) received from the content provider 106. The television content 114(n), for instance, may include additional data for broadcast to the client 104.

One example of this additional data is illustrated in FIG. 1 as electronic program guide (EPG) data 116(e), where “e” can be any integer from one to “E”. The EPG data 116(e) may be obtained from an EPG database for broadcast to the client 104, such as through use of a carousel file system. The carousel file system repeatedly broadcasts the EPG data over an out-of-band (OOB) channel to the client 104 over the network connection 108. Distribution from the head end 102 to the client 104 may be accommodated in a number of ways, including cable, radio frequency (RF), microwave, digital subscriber line (DSL), satellite, via Internet Protocol (IP) connection, and so on. Although the EPG data 116(e) is illustrated as being provided by the head end 102 for the sake of simplicity of the figure, it should be readily apparent that the EPG data 116(e) may originate from a wide variety of sources, such as a stand alone third-party provider.

The client 104, as previously stated, may be configured in a variety of ways to receive the television content 114(n) and the EPG data 116(e) over the network connection 108. The client 104 typically includes hardware and software to transport and decrypt content 114(n) and the EPG data 116(e) received from the head end 102 for rendering by the illustrated display device. Although a display device is shown, a variety of other output devices are also contemplated, such as speakers.

The client 104 may also include digital video recorder (DVR) functionality. For instance, the client 104 may include memory 118 to record television content 114(n) as television content 120(c) (where “c” can be any integer from one to “C”) received via the network connection 108 for output to and rendering by the display device. The memory 118 may be configured in a variety of ways, such as a hard disk drive, a removable computer-readable medium (e.g., a writable digital video disc), semiconductor based memory, and so on. Thus, television content 120(c) that is stored in the memory 118 of the client 104 may be copies of the television content 114(n) that was streamed from the head end 102. Additionally, the memory 118 may also be used to store EPG data 116(e) as EPG data 122(d), where “d” can be any integer from one to “D”.

The client 104 includes a communication module 124 that is executable on the client 104 to control content playback on the client 104, such as through the use of one or more “command modes”, i.e., “trick modes”, to tune to a particular channel, order pay-per-view content, and so on. The command modes may provide non-linear playback of the content 120(c) (i.e., time shift the playback of the content 120(c)) such as pause, rewind, fast forward, slow motion playback, and the like.

The head end 102 is illustrated as including a manager module 126. The manager module 126 is representative of functionality to configure television content 114(n) for output (e.g., streaming) over the network connection 108 to the client 104. The manager module 126, for instance, may configure content 112(k) received from the content provider 106 to be suitable for transmission over the network connection 108, such as to “packetize” the content for distribution over the Internet, configuration for a particular broadcast channel, map the television content 112(k) to particular channels, and so on.

Thus, in the environment 100 of FIG. 1, the content provider 106 may broadcast the television content 112(k) over a network connection 110 to a multiplicity of network operators, an example of which is illustrated as head end 102. The head end 102 may then stream the television content 114(n) over a network connection to a multitude of clients, an example of which is illustrated as client 104. The client 104 may then store the television content 114(n) in the memory 118 as television content 120(c) and/or render the television content 114(n) immediately for output as it is received, such as when the client 104 is configured to include digital video recorder (DVR) functionality.

The client is illustrated as executing the communication module 124 on a processor 128, which is also storable in memory 118. Processors are not limited by the materials from which they are formed or the processing mechanisms employed therein. For example, processors may be comprised of semiconductor(s) and/or transistors (e.g., electronic integrated circuits (ICs)). In such a context, processor-executable instructions may be electronically-executable instructions. Additionally, although a single memory 118 is shown for the client 104, a wide variety of types and combinations of memory may be employed, such as random access memory (RAM), hard disk memory, removable medium memory, and other types of computer-readable media.

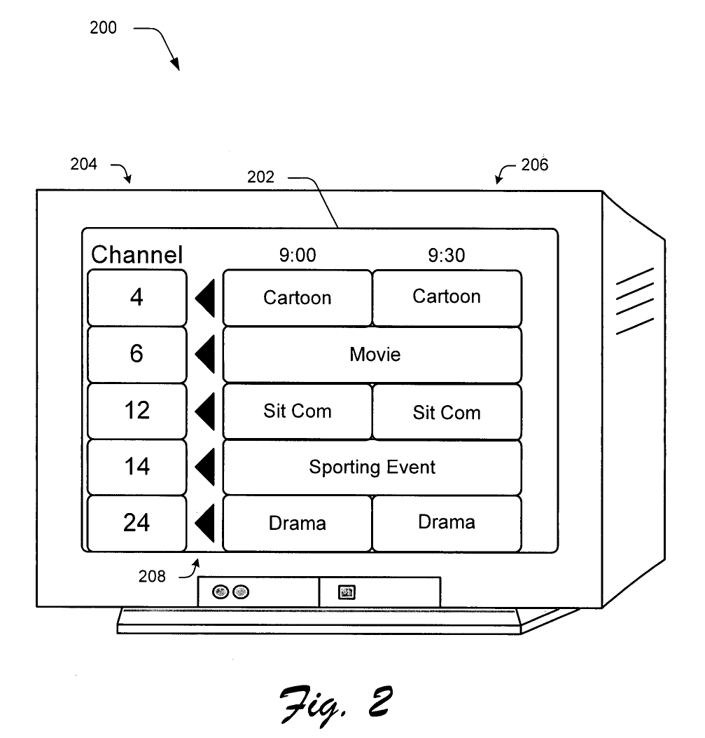

The communication module 124 is also illustrated as including an EPG module 130 which is representative of functionality that may be employed to generate and manage an EPG from the EPG data 122(d). For instance, the EPG module 130 may receive EPG data 116(e) from the head end 102 (e.g., directly and/or from memory 118 as EPG data 122(d)) and process the data to create and output an EPG, an example of which is further discussed in relation to FIG. 2. The EPG module 130 may also provide additional functionality related to interaction of a user with the EPG.

The EPG module 130, for instance, may employ techniques to persist EPG data 122(d) even after referenced television content 120(c) has been broadcast. For example, the EPG module 130 may permit access to the EPG data 122(d) regardless of whether corresponding television content 120(c) has already been “aired”. The EPG module 130 may then provide a variety of functionality to associate events to occur through interaction with the television content that has already “passed”.

The EPG module 130, for example, may output an EPG having a reference to television content that has already been broadcast at a particular date and time as indicated in the EPG. Upon selection of this content, events may be scheduled that relate to other television content. The past television content, for instance, may be an episode of a television series. Upon selection of the past television content, an option may be output to record future episodes of the television series. In this way, a user may quickly locate television content that is known to have been broadcast and use this knowledge to interact with additional functionality. Although scheduling of future episodes has been described in this example, a variety of different events may be scheduled such as reminders and so forth, further discussion of which may be found in relation to the following figures.

It should be noted that one or more of the entities shown in FIG. 1 may be further divided (e.g., the head end 102 may be implemented by a plurality of servers in a distributed computing system), combined (e.g., the head end 102 may incorporate functionality to generate the EPG data 116(e)), and so on and thus the environment 100 of FIG. 1 is illustrative of one of a plurality of different environments that may employ the described techniques.

Generally, any of the functions described herein can be implemented using software, firmware, hardware (e.g., fixed-logic circuitry), manual processing, or a combination of these implementations. The terms “module”, “functionality”, “engine” and “logic” as used herein generally represent software, firmware, hardware, or a combination thereof. In the case of a software implementation, for instance, the module, functionality, or logic represents program code that performs specified tasks when executed on a processor (e.g., CPU or CPUs). The program code can be stored in one or more computer-readable memory devices, such as the memory 118. The features of the techniques to provide past television content referencing in an EPG are platform-independent, meaning that the techniques may be implemented on a variety of-commercial computing platforms having a variety of processors.

Exemplary User Interfaces

The following discussion describes exemplary user interfaces that may be output by the previously described exemplary environment, as well as other environments. Thus, although portions of the following discussion refer to the environment 100 of FIG. 1, the following discussion should not necessarily be limited to that environment 100.

FIG. 2 depicts an exemplary implementation 200 of an electronic program guide (EPG) 202 as being output and displayed on a display device that includes functionality to navigate to past television content. The EPG 202 is arranged in a general grid format that includes a column 204 indicating channels that are available to be output by the client 104 and content 206 that is available via the respective channels. Further, the content 206 is also illustrated as being associated with a particular time at which the content 206 is available via a broadcast, such as “Cartoon”, “Movie”, “Sit Com”, “Sporting Event” and “Drama” for 9:00.

The EPG 202 is also illustrated as having a plurality of indications 208 to indicate an ability to navigate to “past” television content, e.g., television content that has already been broadcast at a particular time. For example, a particular item of television content may have a predetermined broadcast time and channel which may be represented in an EPG, after which that particular item of content is considered to have occurred in the “past”, e.g., the broadcast has expired. Thus, even though that television content may be rebroadcast at another time (e.g., a rerun), the original broadcast has still expired or “passed”. The indications 208 are configured to enable navigation back through representations of television content 120(c) that has already been broadcast, an example of which may be found in relation to the following figure.

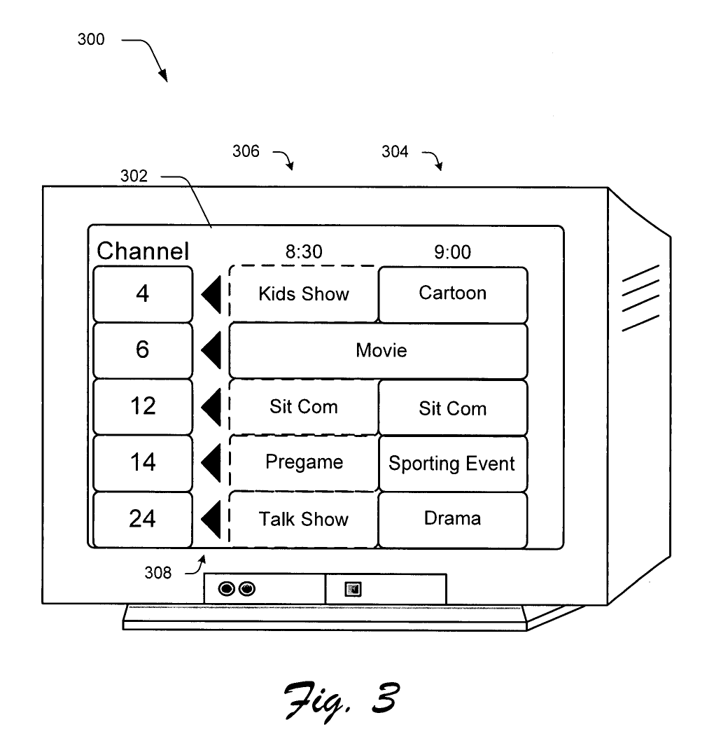

FIG. 3 depicts an exemplary implementation 300 of the electronic program guide (EPG) 202 of FIG. 2 as being output and displayed on a display device to reference past television content. The EPG 302 is output after navigation using the indications 208 of the EPG 202 of FIG. 2. The EPG 302 is illustrated as showing television content that is currently available 304 via broadcast at 9:00 as well as content from the past 306, which is illustrated as 8:30.

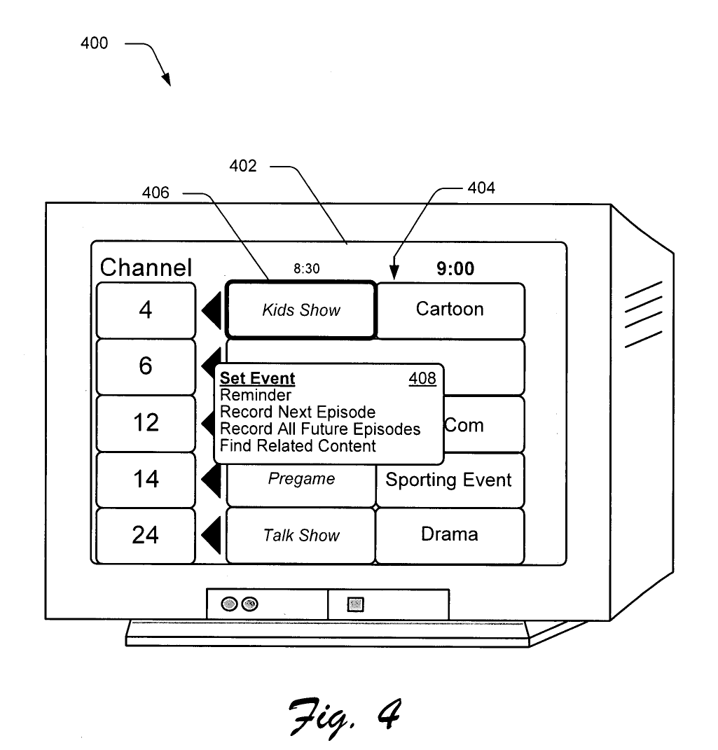

To further distinguish between television content that is available currently and/or in the future from television content that has already been output, the content from the past 306 is displayed differently from the television content that is currently available 304, which is illustrated in FIG. 3 through the use of a dashed border. Other distinguishing techniques are also contemplated, such as use of shadow, different colors, bolding, font size, italics, highlighting, differing contrast, and so on, another example of which is found in relation to FIG. 4.

The EPG 302 is also illustrated as including indications 308 that may be used to navigate further “back in time” through references of television content that has already been broadcast. Although navigation through the use of arrows has been illustrated, it should be readily apparent that a wide variety of other navigation techniques are also contemplated, such as through the use of a keyword search.

FIG. 4 depicts an exemplary implementation 400 of the electronic program guide (EPG) 202 of FIG. 2 as being output and displayed on a display device to set one or more events based on interaction with one or more references to past television content. The EPG 402 in this example distinguishes past television content through the use of italics and a smaller font for a corresponding time at the top of the column, although as previously described a variety of-other techniques are also contemplated. For example, an indication 404 of current time is depicted as an arrow that “moves along” the representations of content during broadcast.

A representation 406 of past television content is illustrated as being selected and/or having focus, which causes output of a popup menu 408. The popup menu 408 is illustrated as including a variety of events that may be scheduled using the representation 406 of past television content, such as to set a reminder, record a next episode of the television content, record all future episodes, find related content (e.g., content in a similar genre, having same or similar actors or directors), and so on. In this way, a variety of events may be scheduled through interaction with the past television content. Although the events are shown as scheduled through a popup menu that is displayed in conjunction with the EPG 402, a variety of other techniques are also contemplated, such as through use of an overlay, through navigation to a “stand alone” screen, and so on.

Exemplary Procedure

The following discussion describes EPG past television content referencing techniques that may be implemented utilizing the previously described environment, systems and devices. Aspects of each of the procedures may be implemented in hardware, firmware, or software, or a combination thereof. The procedures are shown as a set of blocks that specify operations performed by one or more devices and are not necessarily limited to the orders shown for performing the operations by the respective blocks. In portions of the following discussion, reference will be made to the environment 100 of FIG. 1 and the EPGs of FIGS. 2-4, respectively.

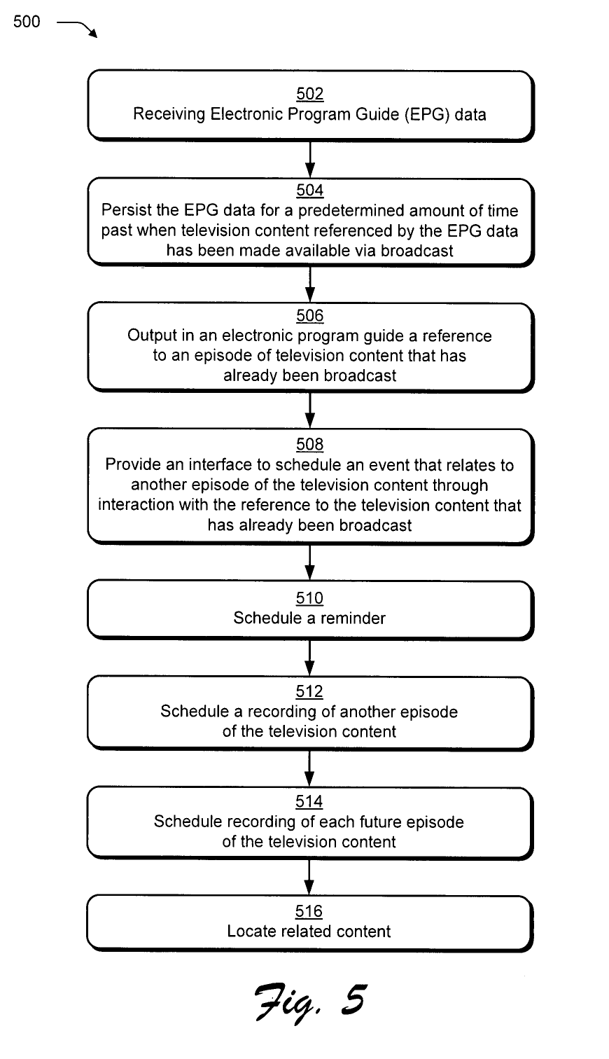

FIG. 5 depicts a procedure 500 in an exemplary implementation in which a reference of an episode of television content that has already been broadcast is output and an interface is provided to schedule an event that relates to another episode of the television content. Electronic program guide (EPG) data is received (block 502). The client 104, for instance, may received EPG data 116(e) from a head end 102 as illustrated in FIG. 1, from a “stand alone” EPG data service (e.g., from a website), and so on.

The client may then persist the EPG data for a predetermined amount of time past when television content referenced by the EPG data has been made available via broadcast (block 504). This may be performed in a variety of ways. For example, data describing each individual item of television content referenced in the EPG data 116(e) may be persisted for a predetermined amount of time by itself, after which it is deleted. In another example, EPG data 116(e) as a group may be persisted for a predetermined amount of time. A variety of other examples are also contemplated, such as through use of a buffer.

A reference to an episode of television content that has already been broadcast is output in an electronic program guide (block 506). The EPG 402 of FIG. 4, for instance, includes a plurality of representations of television content that has already been broadcast, e.g., the content before 9:00.

An interface is provided to schedule an event that relates to another episode of the television content through interaction with the reference to the television content that has already been broadcast (block 508). The interface, for instance, may be configured as a popup menu 408 as illustrated in FIG. 4 which includes different events that may be scheduled based on the referenced past television content. A variety of different events may be scheduled.

For example, a reminder may be scheduled (block 510) such that at or before a broadcast of a future episode of the television content a notification is output to indicate that the episode is soon to be or is available for viewing. In another example, recording of another episode of the television content is scheduled (block 512), such as the future episode as previously described. In a further example, recording of each future episode of the television content is scheduled (block 514). In an implementation, this is performed such that repeated episodes of the television content are not recorded to save storage space in the memory 118 of the client 104. In yet another example, related content is located (block 516) based on the referenced past television content. Television content having similar actors, directors, genre, sequels and/or prequels, and so on may be located. A variety of other examples and instances are also contemplated.

### CONCLUSION

Although the invention has been described in language specific to structural features and/or methodological acts, it is to be understood that the invention defined in the appended claims is not necessarily limited to the specific features or acts described. Rather, the specific features and acts are disclosed as exemplary forms of implementing the claimed invention.

What is claimed is:

1. A method comprising:
outputting in an electronic program guide a reference to an episode of television content that has already been broadcast; and
providing an interface to schedule an-event that relates to another episode of the television content through interaction with the reference to the television content that has already been broadcast.

2. A method as described in claim 1, wherein the episode of the television content that has already been broadcast and the other episode of the television content are part of a television series.

3. A method as described in claim 1, wherein the outputting is performed such that the reference to television content is distinguishable as having already been broadcast from a reference to television content that is currently being broadcast.

4. A method as described in claim 1, wherein the outputting is performed such that the reference to television content is distinguishable as having already been broadcast from a reference to television content that has not yet been broadcast.

5. A method as described in claim 1, wherein the interface is configured to schedule the event by setting a reminder.

6. A method as described in claim 1, wherein the interface is configured to schedule the event by automatically navigating to the other episode of the television content when it is available via a broadcast.

7. A method as described in claim 1, wherein the interface is configured to schedule the event by setting recordation of the other episode of television content.

8. A method as described in claim 1, wherein the interface is configured to schedule the event by setting recordation of television content that includes each future episode of the television series.

9. A method as described in claim 7, wherein the recordation is performed locally at a client that outputs the electronic program guide.

10. A method as described in claim 7, wherein the recordation is performed remotely over a network from a client that outputs the electronic program guide.

11. One or more computer readable media comprising instructions that are executable to display in an electronic program guide a reference to a past episode of television content that is selectable to cause recordation of one or more future episodes of television content.

12. One or more computer readable media as described in claim 11, wherein the past episode and the one or more future episodes form at least a portion of a television series.

13. One or more computer readable media as described in claim 11, wherein the reference to the past episode of television content is output as distinguishable as having already been broadcast from a reference to television content that has not already been broadcast.

14. One or more computer readable media as described in claim 11, wherein the past episode of the television content is selectable to cause recordation of a plurality of future episodes of the television content.

15. A client comprising one or more modules to display a reference to television content that has already been broadcast, wherein the reference is selectable to schedule an event relating to other television content that is not the television content in the displayed reference.

16. A client as described in claim 15, wherein the other television content is another episode of a television series that includes the television content in the displayed reference.

17. A client as described in claim 15, wherein the other television content is not another episode of a television series that includes the television content in the displayed reference.

18. A client as described in claim 15, wherein the scheduled event is to record the other television content.

19. A client as described in claim 15, wherein the scheduled event is to set a reminder regarding the other television content.

20. A client as described in claim 15, wherein the scheduled event is to cause automatic navigation to the other television content when available via a broadcast.
